(19) United States
(12) Patent Application Publication
(10) Pub. No.: US 2010/0150642 A1
(43) Pub. Date: Jun. 17, 2010

(54) RING BINDER

(76) Inventor: Jang-Keun Lee, Gyeonggi-do (KR)

Correspondence Address: Karr Tuttle Campbell;ATTN: PRIYA SINHA CLOUTIER, 1201 Third Ave., Ste 2900, Seattle, WA, 98101, US

(21) Appl. No.: 12/514,575

(22) PCT Filed: Nov. 13, 2007
(86) PCT No.: PCT/KR2007/005693

§ 371 Date: May 12, 2009

(30) Foreign Application Priority Data
Nov. 23, 2006 (KR) 10-2006-0116143

(51) Int. Cl. B42F 13/00

(52) U.S. Cl. 402/24

(57) ABSTRACT

A ring binder is disclosed. The ring binder includes a pair of frames for supporting a load, a pair of semicircular rings arranged on the frames and provided at first ends with a protrusion and an insertion hole, respectively, the semicircular rings being coupled to each other by the protrusion inserted in the insertion hole and being opened and closed when the frames operate to file documents, and a fixing member in which first ends of the frames are fixedly inserted. According to the ring binder, even when a volume thereof is reduced, sufficient strength is maintained and thus the documents can be efficiently filed. In addition, the ring binder can be designed in a variety of structures and shapes.

### TECHNICAL FIELD

The present invention relates to a ring binder. More particularly, the present invention relates to a ring binder that is improved in performance and use convenience by improving and diversifying a structure thereof.

### BACKGROUND ART

A ring binder is generally used to keep documents. Ring binders are classified into 2-hole binders and 3-hole binders in accordance with the number of holes punched in the documents.

A typical ring binder includes a housing, a plurality of semicircular rings that are hinge-coupled to the housing and snap-coupled to each other through a pivot motion relative to each other, and a frame that interconnects the plurality of semicircular rings for the simultaneous pivot motion of the semicircular rings.

In the ring binder structured as described above, when a user pushes or pulls the frame, the semicircular rings pivot in a central direction to be snap-coupled to or separated from each other so that the user can file the documents or separate the documents from the ring binder.

However, the typical ring binder needs predetermined strength to fix the documents. This increases the volume of the binder, thereby increasing manufacturing cost.

Further, since a structure and shape of the typical ring binder is simple, there is a limitation in design and beauty thereof.

The above information disclosed in this Background section is only for enhancement of understanding of the background of the invention and therefore it may contain information that does not form the prior art that is already known in this country to a person of ordinary skill in the art.

### DISCLOSURE

### Technical Problem

### Technical Object

The present invention has been made in an effort to solve the above-described problems. It is an object of the present invention to provide a ring binder that is reduced in volume but has sufficient strength, thereby allowing efficient filing of documents.

It is another object of the present invention to provide a ring binder that can be designed in a variety of shapes by varying a structure thereof.

It is still another object of the present invention to provide a ring binder that can enhance coupling force by improving a structure of semicircular rings.

### Technical Solution

To achieve the objects, the present invention provides a ring binder including a pair of frames for supporting a load; a pair of semicircular rings arranged on the frames and provided at first ends with a protrusion and insertion holes, respectively, the semicircular rings being coupled to each other by the protrusion inserted in the insertion hole and being opened and closed when the frames operate to file documents; and a fixing member in which first ends of the frames are fixedly inserted.

### ADVANTAGEOUS EFFECTS

As described above, the ring binder of the present invention can maintain sufficient strength even when a volume thereof is reduced, thereby allowing efficient filing of the documents.

Further, since the coupling state of the semicircular rings is further enhanced, the frame can be designed to be relatively small.

In addition, by variously changing a structure of the ring binder, the design diversity can be improved.

Various variations and modifications may be devised by those skilled in the art within the scope of the principles of this disclosure and the range of the appended claims of the disclosure the present invention. Therefore, the present invention is not limited to the exemplary embodiments.

### DESCRIPTION OF DRAWINGS

FIG. 1 is a perspective view of a ring binder according to a first exemplary embodiment of the present invention.

FIG. 2 is a side view of a semicircular ring and a frame that are depicted in FIG. 1.

FIG. 3A is a partly enlarged view of a coupling portion between first and second semicircular rings of FIG. 2.

FIG. 3B is a side view of a modified example of the coupling portion between first and second semicircular rings of FIG. 2.

FIG. 4 is a perspective view of a ring binder according to a second exemplary embodiment of the present invention.

FIG. 5 is a side view of a semicircular ring and a frame that are depicted in FIG. 5.

FIG. 6A is a top plan view illustrating a coupling relationship between the semicircular ring and the frame that are depicted in FIG. 4.

FIG. 6B is a top plan view of a modified example of the semicircular ring and the frame that are depicted in FIG. 6A.

FIG. 7 is a perspective view of a ring binder according to a third exemplary embodiment of the present invention.

FIG. 8 is a side view of a semicircular ring and an operational lever that are depicted in FIG. 7.

FIG. 9 is a partly enlarged view of a receiving cap depicted in FIG. 7.

FIG. 10 is a perspective view of a ring binder according to a fourth exemplary embodiment of the present invention.

FIG. 11 is a side view of a semicircular ring and a frame that are depicted in FIG. 10.

FIG. 12 a perspective view of a ring binder according to a fifth exemplary embodiment of the present invention.

FIG. 13 is a side view of a semicircular ring and an operational lever that are depicted in FIG. 12.

FIG. 14 is a perspective view of a ring binder according to a sixth exemplary embodiment of the present invention.

FIG. 15 is a sectional view of the ring binder of FIG. 14.

FIG. 16 is an exploded sectional view illustrating a coupling relationship between the semicircular ring and the frame that are depicted in FIG. 14.

FIG. 17A is a sectional view of a modified example of the semicircular ring and the frame that are depicted in FIG. 14.

FIG. 17B is an exploded sectional view of the ring binder of FIG. 17.

FIG. 18 a perspective view of a ring binder according to a seventh exemplary embodiment of the present invention.

FIG. 19 is a configuration diagram illustrating an internal structure of a handle shown in FIG. 18.

FIG. 20 is a perspective view of a ring binder according to an eighth exemplary embodiment of the present invention.

FIG. 21 is a partial perspective view of a frame and a wire that are depicted in FIG. 20.

FIG. 22 is a side view illustrating a coupling relationship between the first semicircular ring and the frame that are depicted in FIG. 20.

FIG. 23 is a perspective view of a first side of the frame of FIG. 22.

FIG. 24 is a perspective view of a second side of the frame of FIG. 22.

FIG. 25 is a perspective view of a stator shown in FIG. 24.

FIG. 26 is a perspective view illustrating a coupling relationship between the second semicircular ring and the frame that are depicted in FIG. 20.

FIG. 27 is a side view of a modified example of the second semicircular ring of FIG. 26.

FIG. 28 is a perspective view of a modified example of the first semicircular ring of FIG. 20.

FIG. 29 is a perspective view of a modified example of the second semicircular ring of FIG. 26.

FIG. 30 is a partial perspective view of a handle of FIG. 20.

FIG. 31 is a side view of FIG. 30.

FIG. 32 is a partial perspective view of a ring binder according to another exemplary embodiment of the present invention.

### BEST MODE

The following will describe a ring binder according to exemplary embodiments of the present invention with reference to the accompanying drawings.

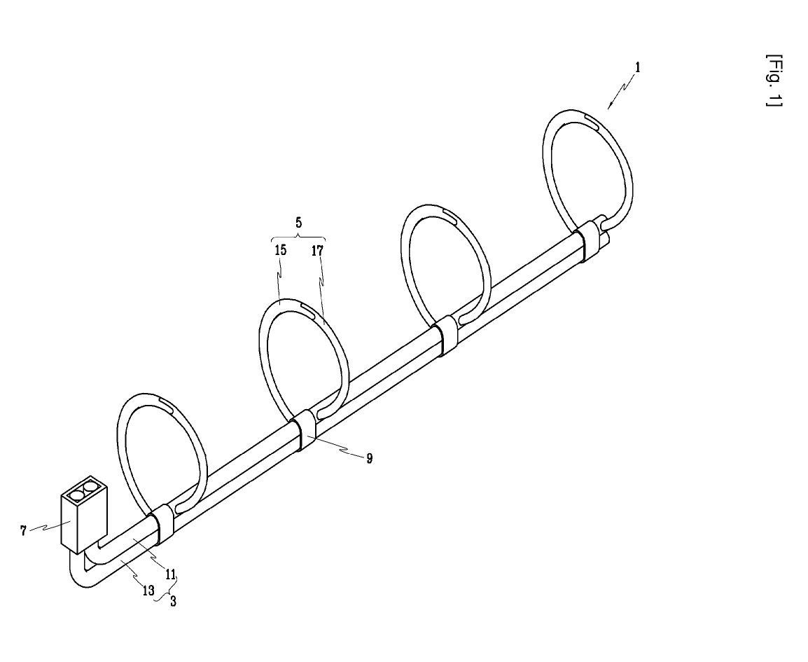

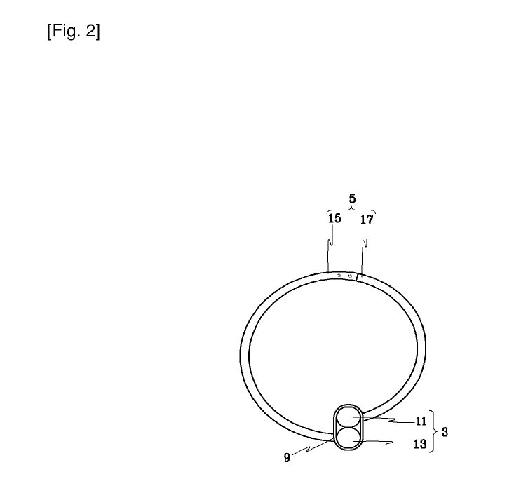

As shown in FIGS. 1 to 3, a ring binder 1 of a first exemplary embodiment includes a frame 3 supporting a load, a plurality of paired semicircular rings 5 that are arranged on the frame 3 to fix documents by being opened and closed, and a fixing member 7 for fixing a side of the frame 3.

In the ring binder having the above-described structure, the frame 3 includes first and second frames 11 and 13 that are arranged in parallel with each other.

Each of the first and the second frames 11 and 13 is formed in a wire shape having predetermined strength. The first and second frames 11 and 13 are disposed one above the other and are connected to each other by connection members 9.

The first frame 11 may be in a simple contact state with inner surfaces of the connection members 9, and the second frame 11 may be in a simple contact state with or fixed to the inner surfaces of the connection members 9.

The connection members 9 are formed of an elastic material to elastically bind the first and second frames 11 and 13 that are arranged one above the other.

The paired semicircular rings 5 are respectively connected to the first and second frames 11 and 13. That is, the paired semicircular rings 5 includes a first semicircular ring 15 fixed to the second frame 13 and a second semicircular ring 17 fixed to the first frame 11.

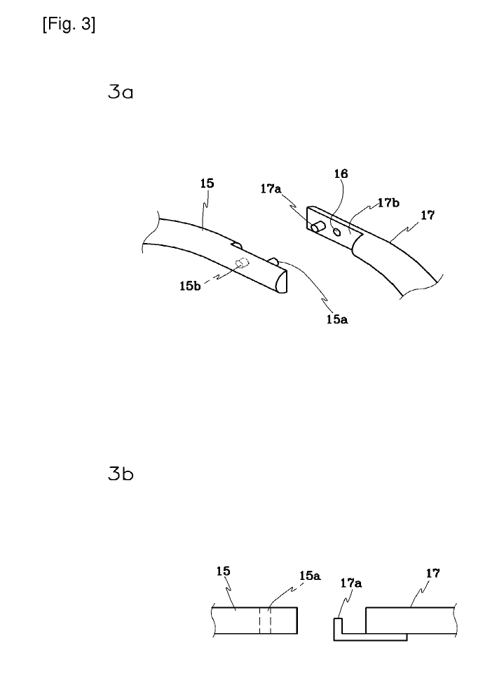

The first and second semicircular rings 15 and 17 are designed such that free end portions thereof are engaged with each other as shown in FIG. 3A. That is, the first and second semicircular rings 15 and 17 are selectively engaged or disengaged with each other.

Namely, the first semicircular ring 15 is provided at the free end portion with a first protrusion 15a and at a portion near the first protrusion with a first insertion groove 15b. The second semicircular ring 17 is also provided with a second protrusion 17a and a second insertion groove 17b. Therefore, when the first and second semicircular rings 15 and 17 are coupled to each other, the first protrusion 15a is inserted in the second insertion groove 17b and the second protrusion 17a is inserted in the first insertion groove 15b.

Further, since the first and second semicircular rings 15 and 17 are coupled to each other by a strong coupling force, an outer force applied to the frames 11 and 13 is applied to the first and second semicircular rings 15 and 17.

In the present exemplary embodiment, since the free end portions of the first and second semicircular rings 15 and 17 respectively provided with the first and second protrusions 15a and 17a are cut in a length direction to define flat surfaces 16, when the free end portions are joined together, a diameter of the joined portion becomes identical to that of each of the first and second semicircular rings 15 and 17.

Resultantly, since the first and second semicircular rings 15 and 17 are coupled to each other in a side-to-side direction, they are coupled to or decoupled from each other only when the frames move in a length direction. Therefore, the frames 11 and 13 can maintain sufficient supporting force against an external force even when the thickness or diameter of each of the frames 11 and 13 is reduced.

As described above, even when the frames 11 and 13 are thin, since the paired semicircular rings 15 and 17 are coupled to the respective frames to provide a spring structure and thus the first and second semicircular rings 15 and 17 are engaged with each other in an assembled state, sufficient supporting force is generated by the semicircular rings even when an additional frame is omitted.

Since the structure of the first and second semicircular rings 15 and 17 are applied to all of the exemplary embodiments that will be described herein, a description thereof will be omitted in the following exemplary embodiments.

FIG. 3B shows a modified example of the first and second semicircular rings.

That is, in the foregoing example, the first and second semicircular rings 15 and 17 are provided at free ends with flat surfaces 16 that will be coupled to each other. However, in this modified example, a protrusion 18a is provided on an end portion of the second semicircular ring 17 and an insertion groove 15a in which the protrusion 17a will be inserted is formed on an end portion of the first semicircular ring 15. The free ends of the semicircular rings are engaged with each other by the insertion of the protrusion 17a into the insertion groove 15a.

The protrusion 17a is attached to a side surface of the second semicircular ring 17 by, for example, welding or with a screw.

First ends of the first and second frames 11 and 13 are bent to define bending portions, and the fixing member 7 is located on the bending portions to form the first and second frames 11 and 13 as an integral frame. The fixing member 7 is provided with a hollow portion. Therefore, the bending portions of the first and second frames 11 and 13 pass through the hollow portion, thereby being fixed by the fixing member 7.

The following will describe a use method of the above-described ring binder. When it is intended to open the pair semicircular rings 15 and 17 that are coupled to each other, the fixing member 7 is pulled upward to be separated from the first and second frames 11 and 13.

In this state, one of the first and second frames 11 and 13 pushes in the length direction to separate the coupled free ends of the first and second semicircular rings 15 and 17 from each other.

That is, the first and second semicircular rings 15 and 17 are separated from each other as shown in FIG. 3A, after which the user grasps the bending portions of the first and second frames 11 and 13 and pivots the first and second frames 11 and 13 in opposite directions, thereby widening the first and second semicircular rings 15 and 17.

In this state, the user files or separates the documents on and from the ring binder 1.

On the contrary, when it is intended to close the ring binder, the process is performed in an opposite order to the above-described process to close the opened semicircular rings 15 and 17 as shown in FIG. 1.

In addition, by inserting the fixing member 7 around the first and second frames 11 and 13, the first and second frames 11 and 13 are fixed.

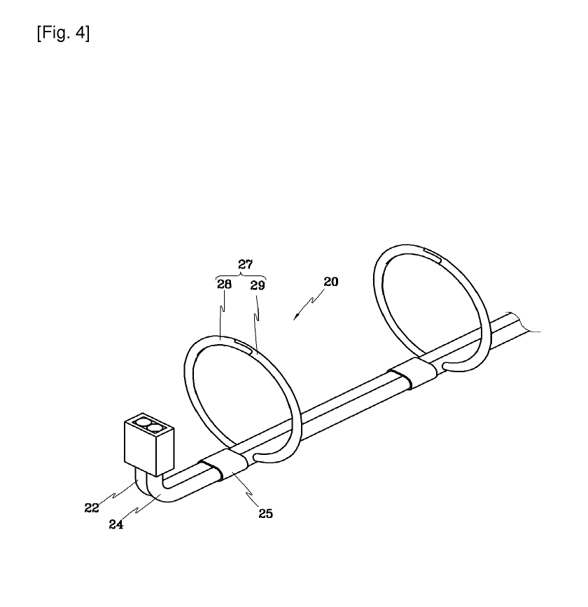

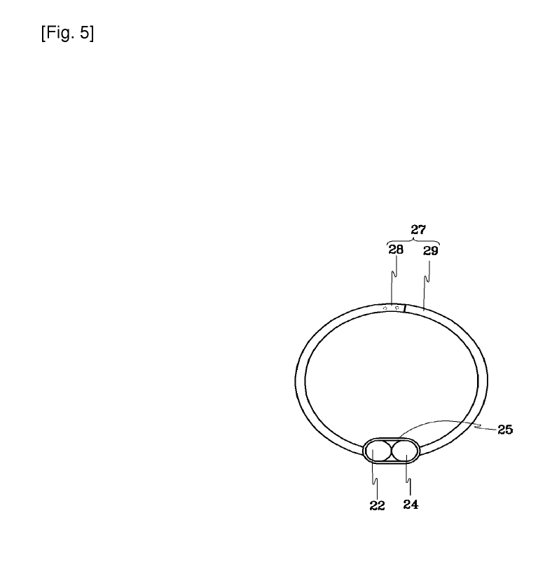

FIGS. 4 to 6 show a ring binder according to another exemplary embodiment of the present invention. The present exemplary embodiment is identical to the foregoing embodiment except that first and second frames 22 and 24 are arranged on a horizontal plane and paired semicircular rings 27 are coupled to the first and second frames 22 and 24.

In more detail, the first and second frames 22 and 24 are arranged side by side and integrally fixed by connection members 25. The first and second frames 22 and 24 are provided at sides with at least one of protrusions 30 and 31 and first ends of the paired semicircular rings 28 and 29 are placed around the protrusions 30 and 31.

That is, the first semicircular ring 28 is placed around the protrusion 30 of the first frame 22 and the second semicircular ring 29 is placed around the protrusion 31 of the second frame 24.

Therefore, if necessary, the first and second semicircular rings 28 and 29 may be placed around or separated from the protrusions 30 and 31 of the first and second frames 22 and 24.

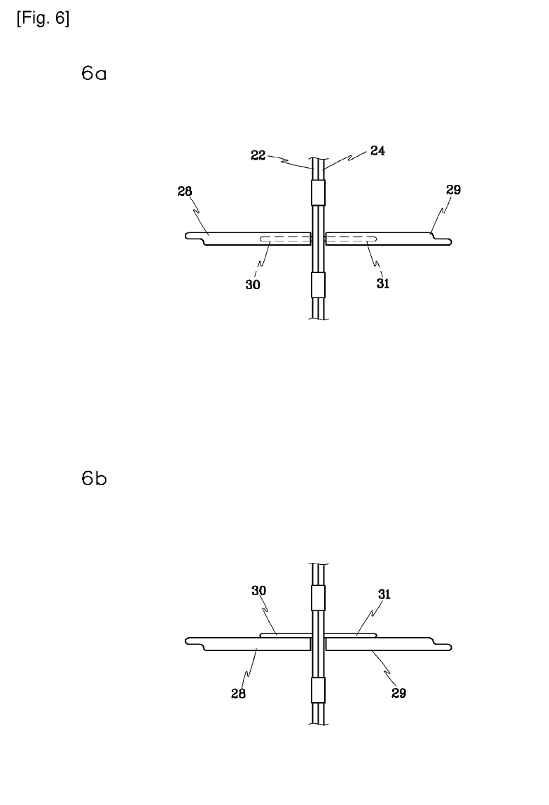

As described above, although the first and second semicircular rings 28 and 29 are fixed by the protrusions 30 and 31, as shown in FIG. 6B, the first and second semicircular rings 28 and 29 may be integrally coupled to the frames 22 and 24 by welding.

That is, the first and second semicircular rings 28 and 29 may be welded on the protrusions 30 and 31 protruding from the first and second frames 22 and 24.

In operation of the ring binder having the above-described structure, the first frame 22 of the first and second frames 22 and 24 arranged in parallel with each other in a horizontal direction is pulled downward to move the second frame 24 downward. By this operation, the first semicircular ring 28 is separated from the second semicircular ring 29, thereby being opened.

When the first frame 22 moves in a reverse direction, the first semicircular ring 28 is coupled to the second semicircular ring 29, thereby realizing a closed state.

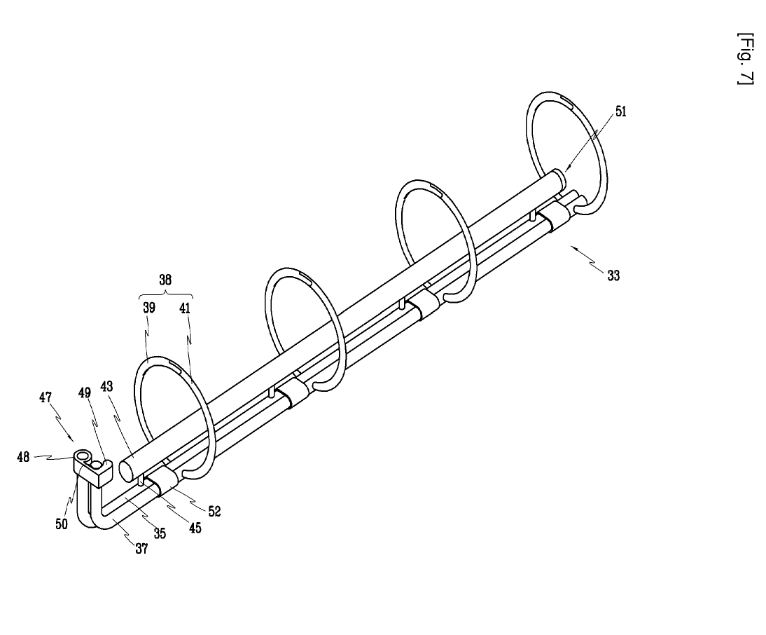

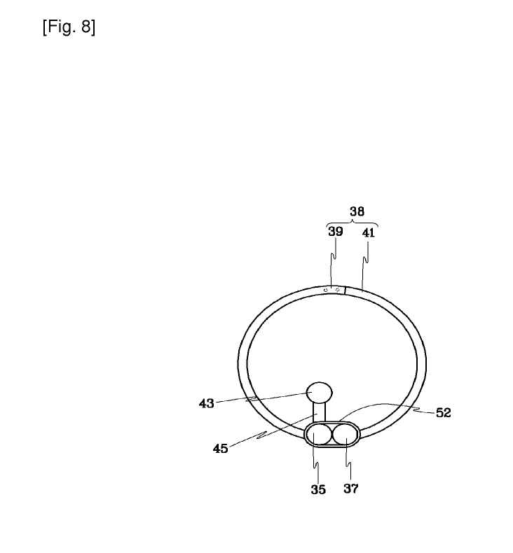

FIGS. 7 to 9 show a ring binder according to another exemplary embodiment of the present invention. The present exemplary embodiment differs from the foregoing embodiment in that a reinforcing shaft is provided.

That is, as shown in the drawings, a ring binder 33 includes first and second frames 35 and 37 that are arranged in parallel with each other, connection members 52 for fixedly interconnecting the first and second frames 35 and 37, a reinforcing shaft 43 connected to a top of the first frame 35 to reinforce the first frame 35, a fixing member 47 for fixing first ends of the first and second frames 35 and 37, and a receiving cap 51 provided on an end of the reinforcing shaft 43.

In the ring binder structured as in the above, since structures of the first and second frames 35 and 37 and the connection members 52 are identical to those of the foregoing embodiments, detailed description thereof will be omitted herein.

The reinforcing shaft 43 is connected to the first frame 35 by a plurality of connection bars 45. Therefore, the strength of the first frame 35 is enhanced by the reinforcing shaft 43 and thus the first and second frames 34 are not damaged or deformed even when an external force of a predetermined level is applied.

Further, the fixing member 47 includes an insertion portion 48 in which the first end of the first frame 35 is inserted and a protruding portion 49 for fixing the second frame 37 at a predetermined location. At this point, a clearance 50 is formed at a side of the protruding portion 49.

The first end of the second frame 37 is located in the clearance 50, thereby being fixed at the predetermined location.

Therefore, when the fixing member 47 rotates counterclockwise, the second fixing member 33 is inserted in the clearance 50 of the protruding portion 49, thereby being fixed.

When the fixing member 47 rotates clockwise, the second frame 37 is separated from the clearance 50 of the protruding portion 49. In this state, when the second frame 37 pivots, the coupling state of the first and second semicircular rings 38 is released. This operation is enabled by an elastic force of the fixing member 47.

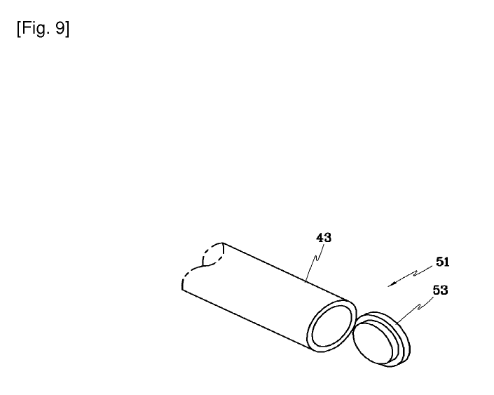

The receiving cap 51 is provided on an end of the reinforcing shaft 43 so that school implements such as a pencil can be received in the reinforcing shaft 43. As shown in FIG. 9, the receiving cap 51 is provided on the end of the reinforcing shaft 43 to be foldable. Therefore, if necessary, the user opens the receiving cap 51 and inserts the school implements into the reinforcing shaft 43, after which the opening of the reinforcing shaft 43 is blocked by the receiving cap 51.

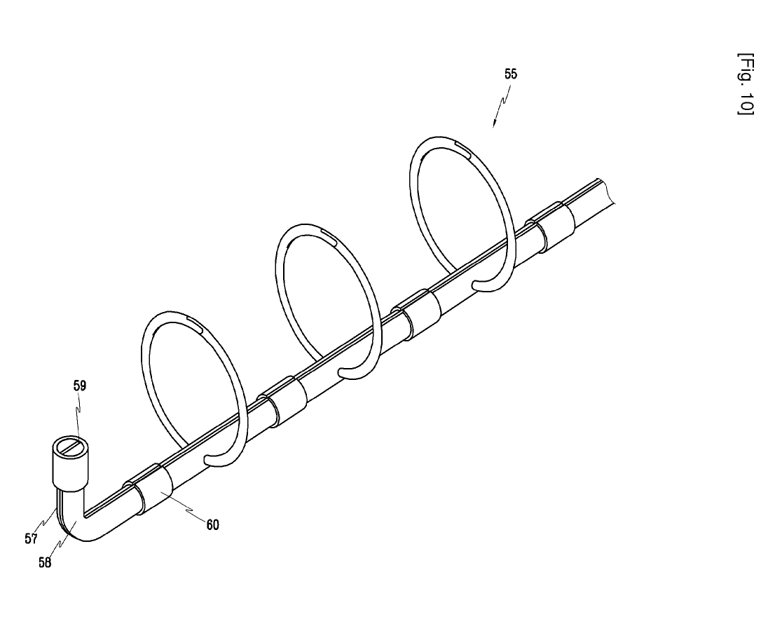

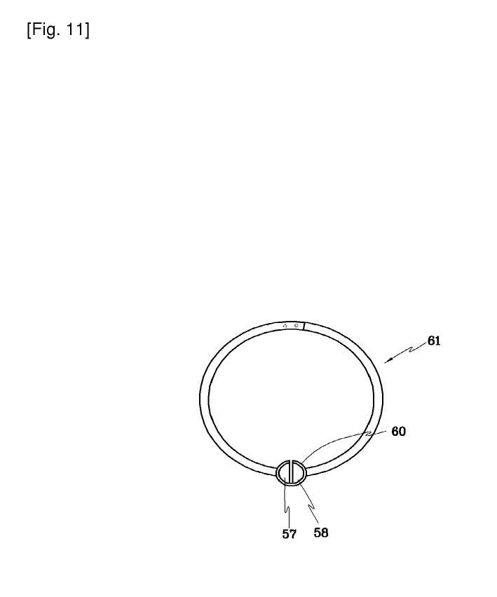

Meanwhile, FIGS. 10 and 11 show another exemplary embodiment of the present invention. The present exemplary embodiment has a difference in shape of the first and second frames 57 and 58.

That is, the frames of the forgoing embodiments have a circular cross-section. In this embodiment, each of a pair of frames 56 formed by the first and second frames 57 and 58 has a semicircular cross-section. The first and second frames 57 and 58 are elastically connected to each other by connection members 60.

At this point, a first inner circumference of the connection member 60 contacts an outer circumference of the first frame 57 and a second inner circumference of the connection member 60 contacts an outer circumference of the second frame 58.

Opposite ends of the connection member 60 are separated from each other and the connection member 60 is formed of an elastic material so that it is biased inward.

Therefore, the first and the second frames 57 and 58 are biased inward by the elastic force of the connection member 60, thereby being formed in an integral frame.

When the first and second frames 57 and 58 are pulled outward, the pulling force overcomes the elastic force of the connection member 60 so that the connection member 60 is widened outward.

Resultantly, the coupling state of the first and second semicircular rings 61 is released and thus the user can separate the documents from the ring binder.

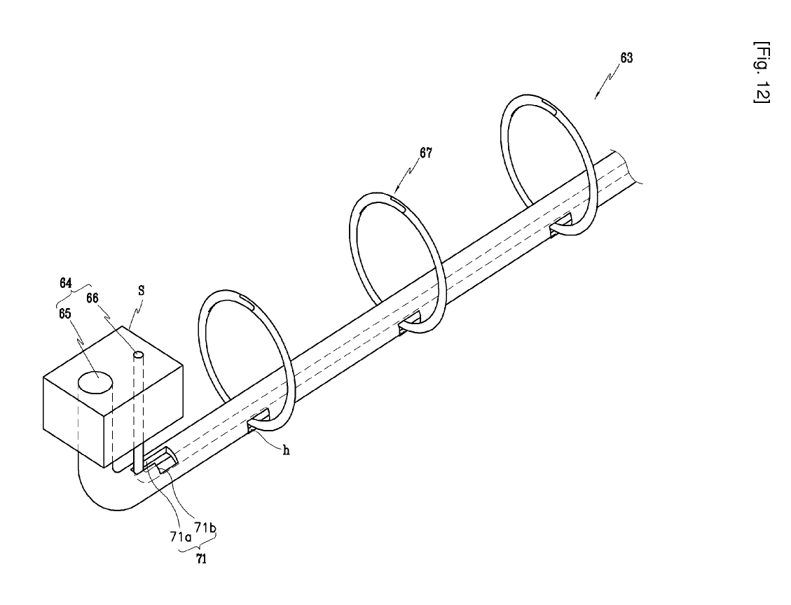

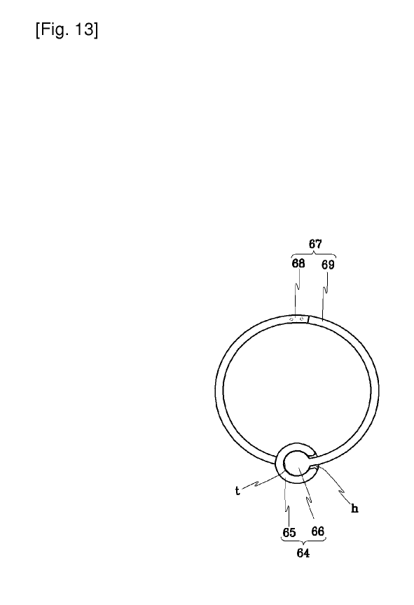

FIGS. 12 and 13 show another exemplary embodiment of the present invention. As shown in the drawings, the present embodiment has a difference in that a second frame 66 is disposed in a first frame 65.

That is, the first frame 65 is formed in a tube shape having an inner space with a predetermined diameter and is provided with a plurality of holes h. The second frame 66 is disposed in the first frame 65 in a length direction.

At this point, a first semicircular ring 68 is connected to the first frame 65 and a second semicircular ring 69 is connected to the second frame 66. The connection structure between the semicircular ring and the frames is the same as or similar to that of the first and second embodiments.

The second semicircular ring 69 protrudes through the hole h of the first frame 65 and is coupled to the first semicircular ring 68.

In addition, a bending portion of the second frame protrudes upward through a hole 71 formed in the first frame.

The hole 71 formed in the first frame 65 has a straight section 71a formed along a length and a curved section 71b formed along a circumference.

Therefore, when a first end of the second frame 66 is pushed in the length direction and rotates, the second semicircular ring 69 rotates to be separated from the first semicircular ring 68.

When the second frame 66 is pushed frontward or pulled rearward, the first and second semicircular rings 68 and 67 move frontward or rearward and thus the coupling location between the first and second semicircular rings 68 and 67 is misaligned.

Further, first end portions of the first and second frames 65 and 66 may be fixed by a fixing portion S. The fixing portion S may be formed in a hexahedron shape, and is provided such that the first end portions of the first and second frames 65 and 66 can be inserted therein.

Therefore, when the fixing portion S is provided over the first end portions of the first and second frames 65 and 66, the first and second frames 65 and 66 are fixed. When the fixing portion S is released from the first end portions of the first and second frames 65 and 66, the first and second frames 65 and 66 are separated from each other.

Therefore, the first and second semicircular rings 68 and 67 are coupled to each other by the operation of the second frame, thereby binding the documents.

At this point, since the first and second semicircular rings 68 and 67 are placed around the protrusions as described above, sufficient coupling force relative to an opening/closing direction can be maintained.

Therefore, since the only function of the first and the second frames 65 and 66 is to induce the first and second semicircular rings 68 and 67 to be fixed in parallel, the diameter can be minimized.

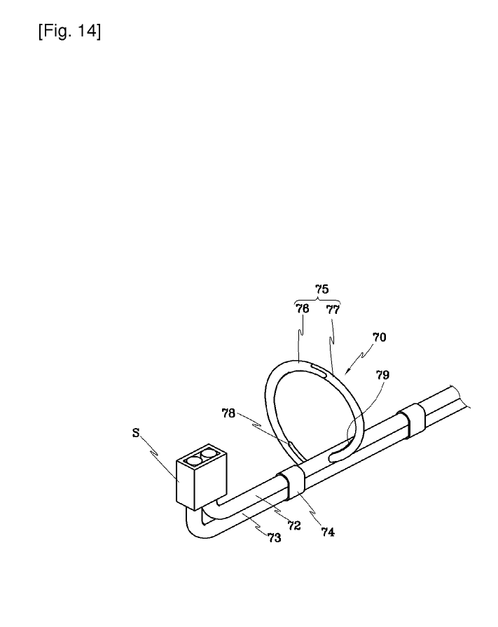

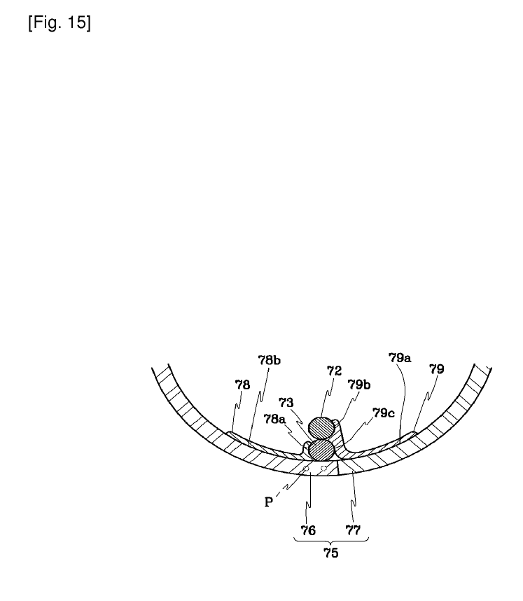

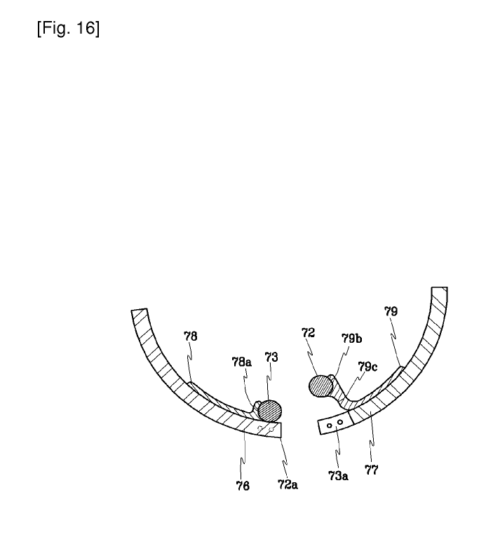

FIGS. 14 to 16 show another exemplary embodiment of the present invention. As shown in the drawings, a ring binder of the present exemplary embodiment includes a first frame 72, a second frame 73 disposed under the first frame 72, connection members 74 integrally connecting the first and second frames 72 and 73 to each other, first and second supports 79 and 78 respectively connected to the first and second frames, first and second semicircular rings 76 and 77 that are respectively fixed to the first and second supports 79 and 78 to bind the documents, and a fixing portion S fixing the first and second semicircular rings 76 and 77.

In the ring binder having the above-described structure, the first and second frames 72 and 73 are interconnected by the connection members 74.

The first support 79 extends in a side direction in a state where it is fixed on a first side of the first frame 72.

A first side surface 79b of the first support 79 is integrally coupled to the first frame 72 by welding or a screw, and a second side surface 79a of the first support is attached to an inner circumference of the first semicircular ring 77.

A curved surface 79c of the first support 79 has a concave shape and is not attached to but contacts the outer circumference of the second frame 73.

In addition, the first semicircular ring 77 is attached to an outer side of the first support 79 but not directly attached to the first frame 72.

The second support 78 is fixed on a first side of the second frame 73 and extends in a side direction. That is, a first side surface 78a of the second support 78 is integrally connected to the second frame 73 by, for example, welding, and a second side surface 78b is attached to an inner circumference of the second semicircular ring.

At this point, the second semicircular ring 76 is attached to an outer side of the second support 78 but the second frame 73 is not directly connected to the second support 78.

When it is intended to couple the semicircular ring having the above-described structure to the support, the second support 78 contacts the curved surface 79c of the first support 79 and the first and second frames 72 and 73 are fixed by the connection members 74, thereby coupling the semicircular ring to the support. If necessary, lower ends of the first and second semicircular rings 76 and 77 may be coupled to each other by a pin P.

When it is intended to separate the first and second semicircular rings 76 and 77 from each other, one of the first and second frames 72 and 73 is pushed in an axial direction to separate the first and second semicircular rings 76 and 77 from each other.

The first and second semicircular rings 76 and 77 are pushed outward with respect to the first and second frames 72 and 73, and the first and second supports 79 and 78 rotate and thus the first and second semicircular rings 76 and 77 are separated from each other.

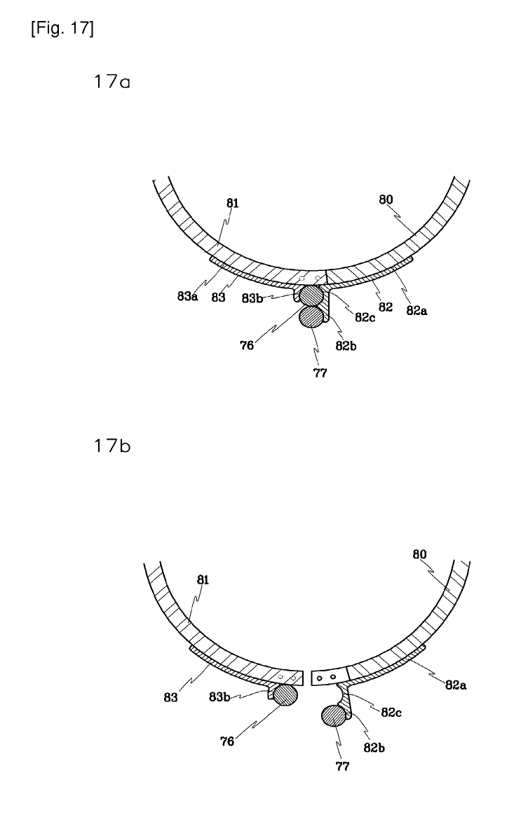

Meanwhile, in the exemplary embodiment, the first and second semicircular rings 76 and 77 are attached to outer circumferences of the first and second supports 79 and 78. However, as shown in FIG. 17A and FIG. 17B, in another embodiment, first and second semicircular rings 80 and 81 are attached to outer circumferences of the first and second supports 82 and 83.

That is, a first surface 82b of the first support 82 is connected to the first frame 77, and the first semicircular ring 80 is fixed to the first support 82 by welding or other fasteners.

A curved surface 82c of the first support 82 is concave, and the second frame 76 is not fixed to but simply contacts the curved surface 82c.

The first surface 83b of the second support 83 is connected to the second frame 76, and an inner circumference of the second support 83 is attached to the second semicircular ring 81.

Therefore, by rotating the first and second supports 82 and 83, the first and second semicircular rings 80 and 81 can be engaged with each other or separated from each other.

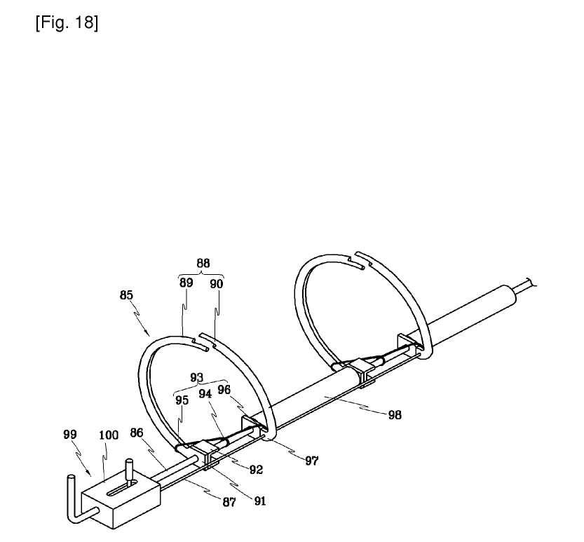

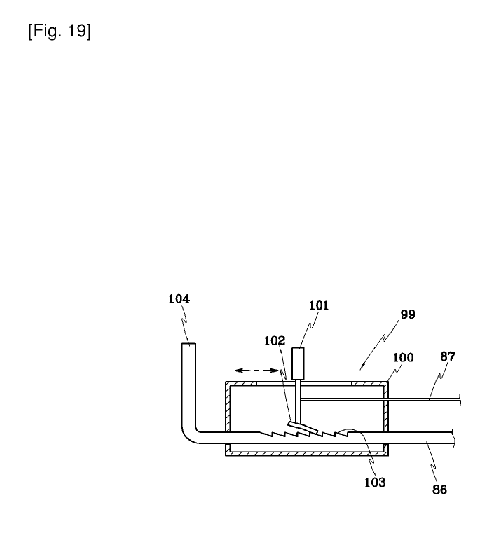

FIGS. 18 and 19 show a ring binder according to another exemplary embodiment of the present invention. As shown in the drawings, a ring binder 85 of the present exemplary embodiment includes a frame 86, a plurality of first semicircular rings 89 that are movably arranged on the frame 86 and maintain a mutual coupling state, a plurality of second semicircular rings 90 coupled to the first semicircular rings 89 and having a lower end connected to a wire 87, a spring member 93 for biasing the first and second semicircular rings 89 and 90 in a decoupling direction, and an adjusting portion 99 for adjusting the frame 86 and the wire 87.

As an elastic member 98 is arranged between the first and second semicircular rings 89 and 90, a gap between the first and second semicircular rings 89 and 90 is uniformly maintained.

A first plate 91 is connected to a first end of the first semicircular ring 89 and a second plate 97 is connected to a first end of the second semicircular ring 90. As the frame 86 penetrates the first and second plates 91 and 97, the first semicircular ring 89 is fixed on the frame 86.

A guide 92 is provided on a first surface of the first plate 91. The second plate 97 is inserted in the guide 92 so that the first and second plates 91 and 97 are fixed to each other.

That is, when the wire 87 is pulled, the second semicircular ring 90 is also pulled and thus the first and second semicircular rings 89 and 90 are coupled to each other.

The spring 93 biases the first and second semicircular rings 89 and 90 toward the frame 86 to separate the first and second semicircular rings 89 and 90 from each other.

That is, the spring 93 includes a first leg 95 supported on the first plate 91, a second leg 96 supported on the second plate 97, and an elastic portion 94 elastically connecting the first and second legs 95 and 96 to each other.

The spring member 93 may be a compression spring that biases the first and second plates 91 and 97 in an opposite direction along the frame 86 to separate the first and second semicircular rings 89 and 90.

When the wire 87 is pulled, the second semicircular rings 90 are also pulled and thus the second semicircular rings are coupled to the first semicircular rings 89. Therefore, when the wire 87 is pulled, the second semicircular rings 90 are pulled and thus the second semiconductor rings 90 are coupled to the first semicircular rings 89.

Although the wire is provided by way of example, the present invention is not limited to this embodiment. For example, a fabric strip or rubber may be used.

The adjusting portion 99 controls the opening/closing of the semicircular rings 88 by adjusting the wire 87.

The adjusting portion 99 includes a case 100, a handle 104 that extends from an end of the frame 86 and penetrates the inside of the case 100 to protrude out of the case 100, and a movable handle 101 that controls a length of the wire by being sequentially caught on the handle 104 in a state where it is connected to the wire 87.

The handle 104 is provided with a plurality of threads 103. The movable handle 101 is engaged with the threads 103. A hook member 102 is mounted on a lower portion of the movable handle 101 to be sequentially hooked on the threads 103.

Therefore, when the movable handle 101 is pulled, the hook member 102 is sequentially hooked on the threads, thereby enabling the adjustment of the length of the wire 87.

On the contrary, when the movable handle 101 is lifted, the movable handle 101 moves frontward by the elastic force of the spring 93. In addition, by pressing the movable handle 101 at an appropriate position, the hook member 102 is hooked on the threads 103.

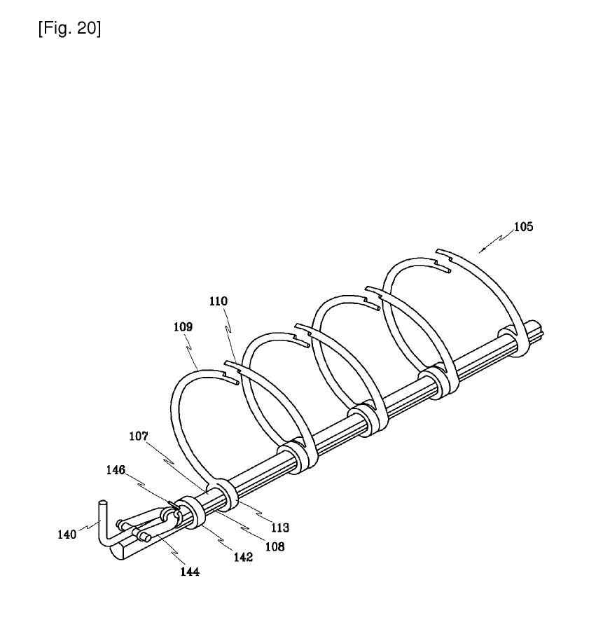

FIG. 20 shows a ring binder according to another exemplary embodiment of the present invention. That is, as shown in the drawing, a ring binder 105 of the present exemplary embodiment includes a frame 107, a plurality of first semicircular rings 109 movably arranged on the frame, a plurality of second semicircular rings 110 that are arranged on the frame 107, are capable of rotating about the frame, and function as springs by being coupled to the first semicircular rings 109, a wire 108 interconnecting the first semicircular rings 109 and pulling the first semicircular rings 109 in a direction, and a handle 140 that is connected to an end of the wire to adjust the wire 108.

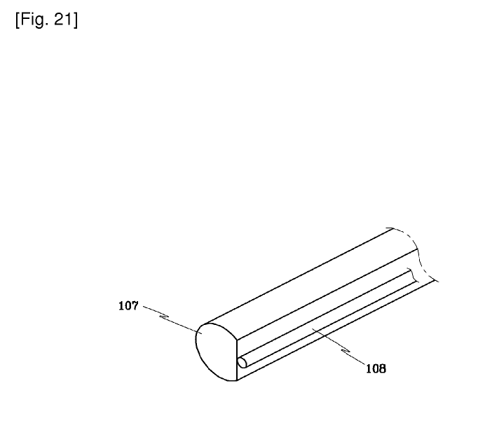

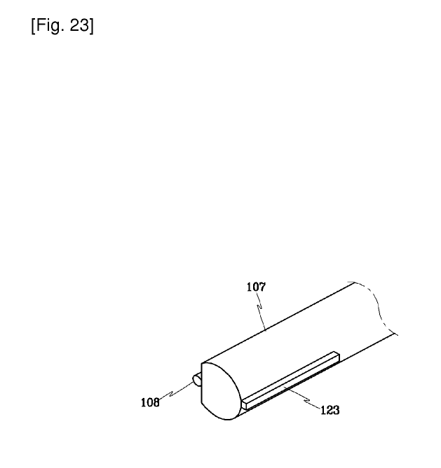

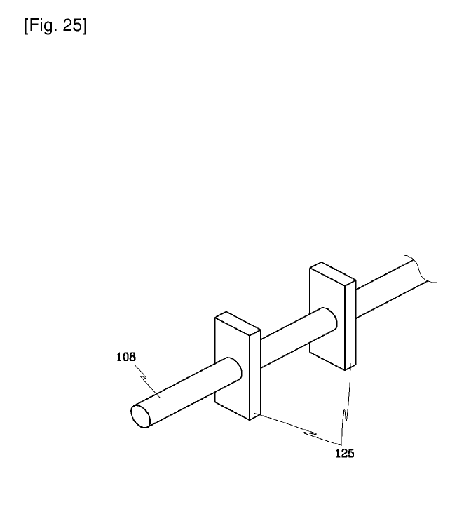

In the ring binder having the above-described structure, as shown in FIGS. 21 to 27, the frame 107 has a semicircular cross-section. The first semicircular rings 109 are inserted in the frame 107 and thus can move frontward and rearward along the frame 107.

That is, a protrusion 123 is formed on a first side surface of the frame 107, and a stator 125 is provided on a second side surface of the frame 107.

The protrusion 123 extends from an outer circumference of the frame 107 in a predetermined length and is inserted in a groove 122 formed on an inner circumference of the first semicircular ring 109. Therefore, the first semicircular rings 109 can rotate together with the frame 107, clockwise or counterclockwise.

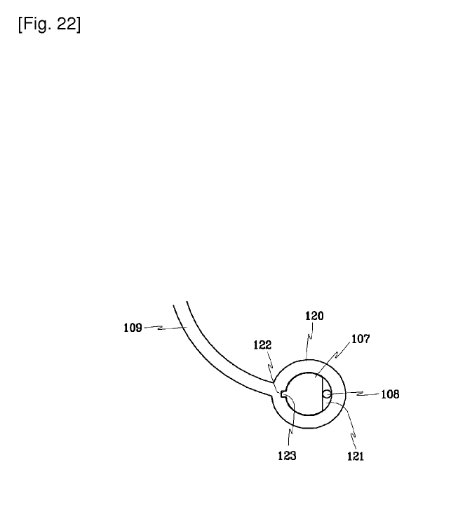

As shown in FIGS. 22 to 25, the protrusion 123 has a rectangular section. Therefore, when the protrusion 123 is inserted in the groove 122 of the first semicircular ring 109 and external force is applied to the first semicircular ring 109, and the protrusion 123 functions to guide the movement of the first semicircular ring 109 in an axial direction of the frame 107.

In addition, the stator 125 includes a pair of vertical bars that are mounted on both side surfaces of the first semicircular ring 109. The vertical bars are interconnected by the wire 108 and, in this state, contact the second surface of the frame 107.

Therefore, when the wire 108 is pulled, the stator 125 is also pulled to pull the first semicircular ring 109.

The second semicircular ring 110 is limited in a forward/rearward movement on the frame 107, but is allowed rotational motion.

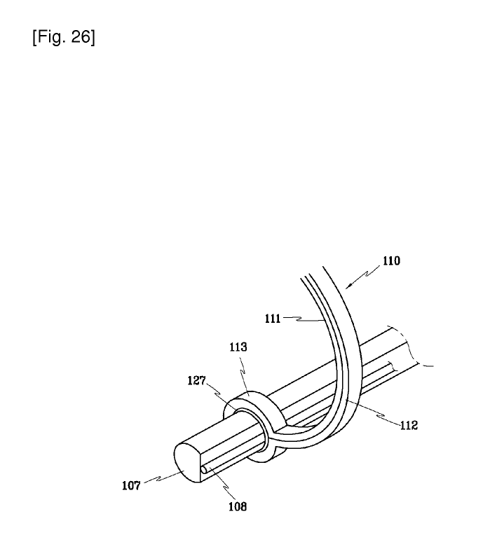

That is, as shown in FIG. 26, the second semicircular ring 110 has an inner plate 111 and an outer plate 112 that are integrally attached to each other by, for example, welding, to define a ring portion 113.

The ring portion 113 has a circular cross-section. Therefore, the ring portion 113 is inserted in the frame 107 to be capable of rotating.

Fixing rings 127 are provided on both sides of the second semicircular ring 110 to prevent the second semicircular ring 110 from moving in a lateral direction. The fixing ring 127 is fixed on the outer circumference of the frame 107 by welding.

Therefore, the second semicircular ring 110 is limited in movement in an axial direction but is allowed rotational motion.

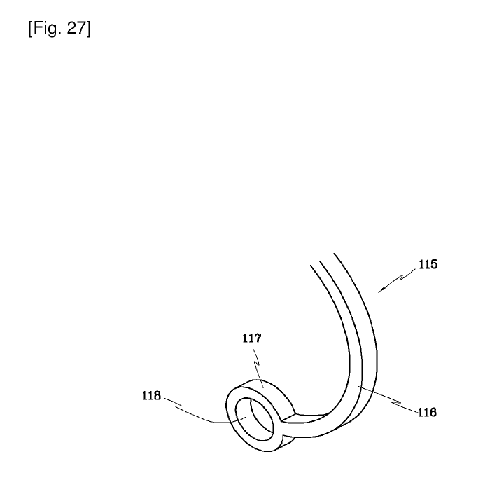

As shown in FIG. 27, the second semicircular ring 110 may be formed in an integral body rather than as two parts (outer and inner parts).

The wire 108 has a conventional structure and is connected to the handle 140 through a loop 144 to connect the first semicircular rings 109 to the stator 125.

The handle 140 is hooked on or released from a hook protrusion 146 formed on the frame 107, thereby pulling or fixing the wire 108.

Accordingly, by pulling the wire 108, the first semicircular rings 109 can move along the frame in an axial direction.

At this point, the first and second semicircular rings 109 and 110 are disposed in a spring shape and thus the shape is changed into a triangular shape when external force is applied, thereby further enhancing strength.

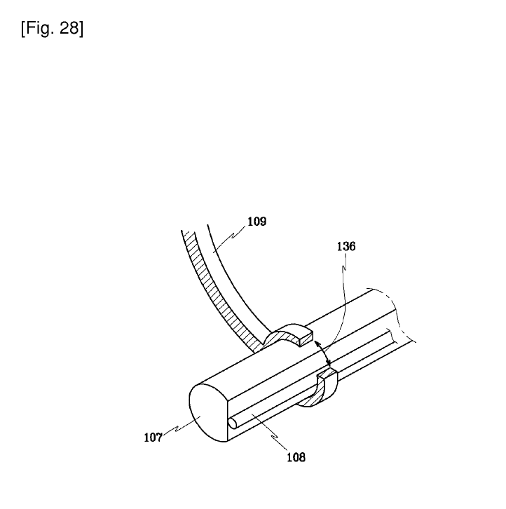

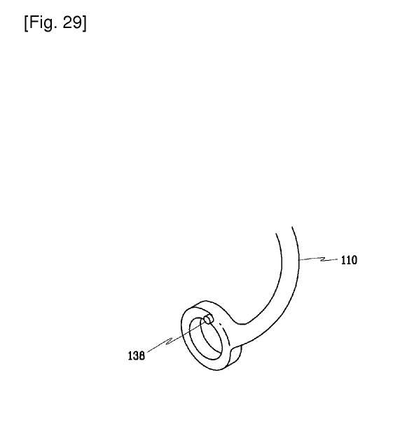

The first and second semicircular rings 109 and 110 may be formed in shapes shown in FIGS. 28 and 29.

That is, a predetermined section of the first semicircular ring 132 is cut to define a space 136.

A protrusion 138 is formed on a first side surface of the second semicircular ring 110.

Therefore, when the second semicircular ring 110 rotates, the protrusion 138 is capable of rotating in a space of the first semicircular ring 109.

In this case, a rotational radius of the second semicircular ring 110 can be limited within a predetermined range.

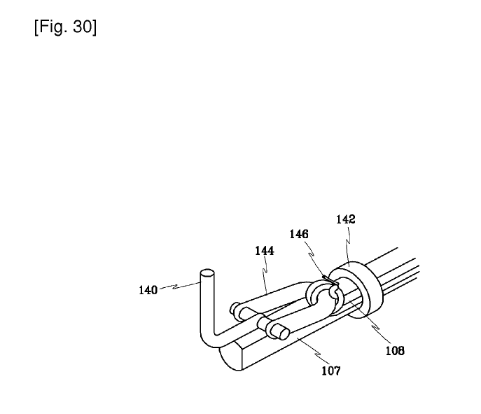

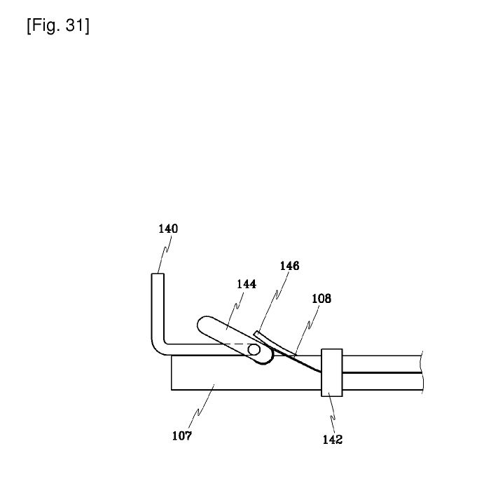

Meanwhile, as shown in FIGS. 30 and 31, the handle 140 is mounted on ends of the frame 107 and the wire 108 to pull the wire 108.

The handle 140 is connected to the wire 108 through the loop 144.

The handle 140 is fixed on the hook protrusion 146 formed on the frame 107 and the wire 108 is fixed on the frame 107 by the connection member 142.

Therefore, when the handle 140 is released from the hook protrusion 146 and pulled, the wire 108 is also pulled to move the semicircular ring 109 forward and rearward.

At this point, when the user pulls the second semicircular ring 110, the second semicircular ring 110 is separated from the first semicircular ring 109. Needless to say, the coupling of the first and second semicircular rings 109 and 110 is realized by the user.

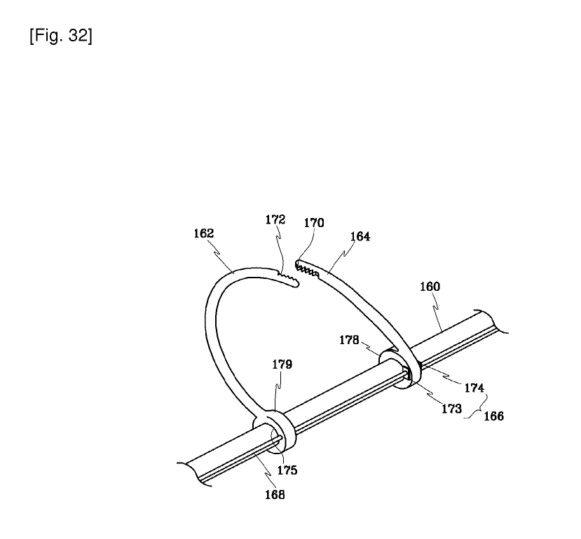

Meanwhile, FIG. 32 shows another exemplary embodiment of the present invention. In the present exemplary embodiment, gears 172 and 170 are formed on end portions of first and second semicircular rings 162 and 164.

That is, the first and second semicircular rings 162 and 164 are provided on a frame 160 and connected to each other by a wire 168.

At this point, the first semicircular ring 162 has a lower end 179 with a cap that is fixed to the frame 160 by welding. The second semicircular ring 164 is movably inserted in the frame 160.

The wire 168 is connected to a stator 166 provided on a lower end 178 of the second semicircular ring 164 after penetrating the lower end 179 of the first semicircular ring 162.

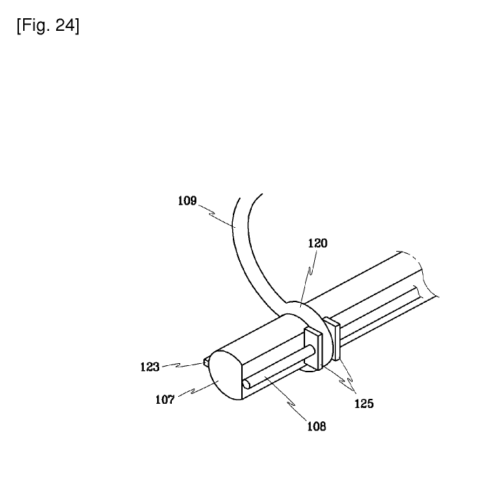

At this point, a structure of the stator 166 is same as that of the stator 125 shown in FIG. 24. That is, the stator 166 includes a pair of vertical bars 173 and 174.

Therefore, when the wire 168 is pulled, the second semicircular ring 164 can move along the frame 164.

Further, a fabric such as nylon may be inserted between the second semicircular ring 164 and the frame 160. When the fabric is provided between the second semicircular ring 164 and the frame 160, the second semicircular ring 164 is pressed on the frame 160 by the fabric. Therefore, when a relatively small force is applied, the second semicircular ring 164 cannot rotate but can move forward and rearward.

In the ring binder having the above-described structure, when it is intended to couple the first and second semicircular rings 162 and 164 to each other, the wire 168 is pulled to move the second semicircular ring 164 toward the first semicircular ring 162. In this state, when the user pushes the first and second semicircular rings 162 and 164, the first and second semicircular rings 162 and 164 move toward each other, so they can be easily coupled as the gears 172 and 170 are formed in an arrow shape.

At this point, the second semicircular ring 164 is in a pressed state on the frame 160 by the fabric, so unintentional release of the second semicircular ring 164 can be prevented.

On the contrary, when it is intended to decouple the first and second semicircular rings 162 and 164 from each other, the wire 168 is pulled in an opposite direction and thus the gears 172 and 170 of the first and second semicircular rings 162 and 164 are disengaged from each other. In this state, the user pulls the first and second semicircular rings 162 and 164 away from each other, thereby realizing an opened state.

At this point, the rotation of the second semicircular ring 164 may be limited within a predetermined range. That is, as shown in FIGS. 28 and 29, the first semicircular ring 162 is partly cut to define a space 136 (see FIG. 28). A protrusion 138 (see FIG. 28) is formed on a first side surface of the second semicircular ring 164. The protrusion 138 can rotate in the space 136 of the first semicircular ring 162 and thus the rotation radius of the second semicircular ring 164 can be limited within a predetermined range.

As described above, the forming of the first and second semicircular rings in gear shapes is not limited to the present embodiment, but can be applied to the foregoing embodiments.

As described above, the ring binder can be designed in a variety of structures and shapes.

### MODE FOR INVENTION

### Industrial Applicability

The ring binder of the present invention can be used for keeping and filing all kinds of documents.

### Sequence List Text

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is

1. A ring binder comprising:
a pair of frames for supporting a load;
a pair of semicircular rings arranged on the frames and provided at first ends with a protrusion and an insertion hole, respectively, the semicircular rings being coupled to each other by the protrusion inserted in the insertion hole and being opened and closed when the frames operate to file documents; and
a fixing member in which first ends of the frames are fixedly inserted.

2. The ring binder of claim 1, wherein the frames include first and second frames that are arranged in parallel with each other in a vertical or horizontal direction and are interconnected by a connection member.

3. The ring binder of claim 2, wherein the semicircular rings include a first semicircular ring connected to the first frame and a second semicircular ring connected to the second frame, the first semicircular ring is provided with a first protrusion and a first insertion hole, the second semicircular ring is provided with a second protrusion and a second insertion hole, and the first and second semicircular rings are coupled to each other by the first and second protrusions inserted in the second and first insertion holes.

4. The ring binder of claim 2, wherein the semicircular rings are inserted around protrusions formed on the first and second frames, respectively, or fixed to the frames by welding.

5. A ring binder comprising:
a pair of frames that are arranged in parallel with each other to support a load;
at least one pair of semicircular rings arranged on the frames at a predetermined interval and provided at first ends with a protrusion and an insertion hole, respectively, the semicircular rings being coupled to each other by the protrusion inserted in the insertion hole and being opened and closed when the frames operate to file documents;
a connection member interconnecting the frames arranged in parallel with each other in a horizontal direction;
a reinforcing shaft arranged on one of the frames in parallel to enhance the frame strength;
a fixing member that fixes first ends of the frames to be capable of opening and closing; and
a receiving cap provided on an end of the reinforcing shaft to define a receiving space in the reinforcing shaft.

6. The ring binder of claim 5, wherein the frames include first and second frames, the paired semicircular rings include a first semicircular ring connected to the first frame and a second semicircular ring connected to the second frame, the first semicircular ring is provided with a first protrusion and a first insertion hole, the second semicircular ring is provided with a second protrusion and a second insertion hole, and the first and second semicircular rings are coupled to each other by the first and second protrusions inserted in the second and first insertion holes.

7. The ring binder of claim 5, wherein the fixing member includes an insertion portion, which is provided on a first side and in which an end of the first frame is inserted, and a protruding portion, which is provided on a second side and fixes the second frame at a predetermined location, wherein the protruding portion is provided at a side with a clearance in which a first side of the second frame is caught.

8. A ring binder comprising:
a pair of frames that are arranged in parallel with each other to support a load and have a semicircular cross-section;
at least one pair of semicircular rings arranged on the frames and provided at first ends with a protrusion and an insertion holes, respectively, the semicircular rings being coupled to each other by the protrusion inserted in the insertion hole and being opened and closed when the frames operate to file documents;
a connection member fixedly interconnecting the frames arranged in parallel with each other in a horizontal direction; and
a fixing member having an inner circumference enclosing outer circumferences of first ends of the frames to press the frames inward.

9. A ring binder comprising:
a first frame defining an inner space and provided at a side with a hole communicating with the inner space;
a second frame disposed in the inner space of the first frame in parallel;
a first semicircular ring connected to the first frame and provided with a first protrusion and a first insertion hole;
a second semicircular ring connected to the second frame and provided with a second protrusion and a second insertion hole, the first and second semicircular rings being coupled to each other by the first and second protrusions inserted in the second and first insertion holes; and
a handle connected to an end portion of the second semicircular ring and protruding outward through the hole of the first frame, the first and second semicircular rings being coupled to or decoupled from each other by pulling or pushing the handle.

10. A ring binder comprising:
a first frame having a semicircular cross-section and provided at an end with a groove;
a second frame having a semicircular cross-section and inserted in the groove of the first frame;
a connection member for fixing the first and second frames coupled to each other;
first and second supports that are respectively connected to the first and second frames;
first and second semicircular rings providing on an inner or outer portion of the first and second supports and provided at first ends with a protrusion and an insertion hole, respectively, the first and second semicircular rings being coupled to each other by the protrusion inserted in the insertion hole and being opened and closed when the first and second frames operate to file documents; and
a fixing portion for fixing first ends of the first and the second frames.

11. The ring binder of claim 10, wherein the first and second supports are misaligned with each other.

12. A ring binder comprising:
a frame supporting a load;
a plurality of paired semicircular rings provided at first ends with a protrusion and an insertion hole, respectively, the paired semicircular rings being coupled to each other by the protrusion inserted in the insertion hole and being opened and closed when the frames operate to file documents and second ends of the paired semicircular rings being movably inserted in the frame;
a wire for maintaining a coupling state of the paired semicircular rings by pulling the paired semicircular rings;
a spring member for separating the paired semicircular rings from each other by pushing the paired semicircular rings; and
an adjusting portion for adjusting the frame and the wire;

13. The ring binder of claim 12, wherein the paired semicircular rings include first and second semicircular rings, the first semicircular ring is provided at an end with a first plate, the second semicircular ring is provided at an end with a second plate, and the first plate includes a guide for fixing the second plate.

14. The ring binder of claim 12, wherein the spring includes a first leg supported on the first plate, a second leg supported on the second plate, and an elastic portion elastically connecting the first and second legs to each other.

15. The ring binder of claim 12, wherein the adjusting portion includes a case, a handle extending from an end of the frame and penetrating out of the case, and a movable handle that adjusts a length of the wire by being sequentially hooked on the handle in a state where the movable handle is connected to the wire.

16. A ring binder comprising:
a frame supporting a load;
at least one first semicircular ring that is mounted on the frame and movable forward and rearward when external force is applied, the first semicircular ring being provided at an end with a first protrusion and a first insertion hole;
at least one second semicircular ring that is mounted on the frame to be capable of rotating about the frame and is provided at an end with a second protrusion and a second insertion hole that are respectively coupled to or decoupled from the first insertion hole and the first protrusion;
a wire interconnecting the first semicircular rings and that pulls the first semicircular rings along the frame in a direction; and
a handle that is connected to an end of the wire to adjust the wire.

17. The ring binder of claim 16, wherein the frame has a semicircular section so that the frame can be inserted therein, a protrusion is formed on a first side of the frame and inserted in a groove on an inner surface of the first semicircular ring, and a state is provided on a second side of the frame to prevent the first semicircular ring from rotating.

18. The ring binder of claim 17, wherein the stator includes a pair of vertical bars mounted on both side surfaces of the first semicircular ring.

19. The ring binder of claim 16, wherein the second semicircular ring includes a ring portion inserted in the frame, a fixing ring in which both sides of the ring portion are inserted to prevent the second semicircular ring from moving toward the frame, and a fabric member provided between the second semicircular ring and the frame.

20. The ring binder of claim 16, wherein the handle is connected to the wire through a loop, the wire is supported by a connection member, and the second semicircular rings are pulled when the handle is pulled.

21. A ring binder comprising:
a frame supporting a load;
at least one first semicircular ring that is fixedly disposed on the frame and provided at an upper end with a first gear;
at least one second semicircular ring that is movably disposed on the frame at a predetermined distance from the first semicircular ring and provided at an upper portion with a second gear that can be selectively engaged with the first gear;
a stator provided on a lower end of the second semicircular ring; and
a wire that is disposed on the frame and connected to the semicircular ring to couple or decouple the first and second semicircular rings to and from each other by pulling or pushing the second semicircular ring.
